(19) United States
(12) Patent Application Publication
(10) Pub. No.: US 2018/0129929 A1
(43) Pub. Date: May 10, 2018

(54) METHOD AND SYSTEM FOR INFERRING USER VISIT BEHAVIOR OF A USER BASED ON SOCIAL MEDIA CONTENT POSTED ONLINE

(71) Applicant: FUJI XEROX CO., LTD., TOKYO (JP)

(72) Inventors: Ryosuke Shigenaka, Yokohama (JP); Yin-Ying Chen, Sunnyvale, CA (US); Francine Chen, Menlo Park, CA (US); Dhiraj Joshi, Ossining, NY (US); Yukihiro Tsuboshita, Yokahama (JP)

(21) Appl. No.: 15/347,060

(22) Filed: Nov. 9, 2016

(51) Int. Cl. G06N 3/02; G06F 17/30

(52) U.S. Cl. CPC G06N 3/02; G06F 17/30867

(57) ABSTRACT

A method of generating a predictive model of categories of venues visited by a user is provided. The method may include extracting a first content feature from a first digital post to an online social media platform selected from a plurality of digital posts, extracting a second content feature from a second digital post to an online social media platform selected from the plurality of social media posts, aggregating the first and second content features, inferring at least one of a frequency and a regularity of visits to a venue category associated with the plurality of digital posts based on the aggregated first and second content features using a neural network, and determining at least one of a frequently visited venue category and a regularly visited venue category based on the inferred frequency and a regularity of visits associated with the plurality of digital posts.

### BACKGROUND

### Field

The present disclosure relates to online social media networks, and more specifically, to systems and methods of using online social media networks to perform inference analysis of business venue usage patterns.

### Related Art

In related art customer management systems, user visit behavior may be important information for marketing. The user visit behavior may be determined using customer surveys (e.g., filling out a feedback sheet after a visit). In these related art systems, frequency (e.g., occurrences of user visits to a business venue within a specific time period) and regularity (e.g., time intervals between venue visits) are two of the most common patterns of interest examined in customer surveys. Using the survey information, business managers attempt to understand their customer's visit behavior, offer better services, and better serve user needs. Additionally, based on this visit behavior information, business managers may try to send relevant coupons for the businesses that the customers visit most frequently, or may offer discounts periodically to the users who visit regularly.

However, survey data can be unreliable because some users may respond to the survey or may not be completely honest when they do reply. To address this problem, some related art systems examine social media check-in information to determine user visit behavior. However, user check-in data may be limited and not always be available (e.g., due to user settings associated with check-in data or a user may not use the check-in functionality available on social media platforms), reducing generalization capabilities of systems that utilize check-in information exclusively.

### SUMMARY OF THE DISCLOSURE

Aspects of the present disclosure include a method of generating a predictive model of categories of venues visited by a user. The method includes extracting a first content feature from a first digital post to an online social media platform selected from a plurality of digital posts, extracting a second content feature from a second digital post to an online social media platform selected from the plurality of social media posts, aggregating the first and second content features, inferring at least one of a frequency and a regularity of visits to a venue category associated with the plurality of digital posts based on the aggregated first and second content features using a neural network, and determining at least one of a frequently visited venue category and a regularly visited venue category based on the inferred frequency and a regularity of visits associated with the plurality of digital posts.

Additional aspects of the present disclosure include a non-transitory computer readable medium having stored therein a program for making a computer execute a method of generating a predictive model of categories of venues visited by a user. The method includes extracting a first content feature from a first digital post to an online social media platform selected from a plurality of digital posts, extracting a second content feature from a second digital post to an online social media platform selected from the plurality of social media posts, aggregating the first and second content features, inferring at least one of a frequency and a regularity of visits to a venue category associated with the plurality of digital posts based on the aggregated first and second content features using a neural network, and determining at least one of a frequently visited venue category and a regularly visited venue category based on the inferred frequency and a regularity of visits associated with the plurality of digital posts.

Additional aspects of the present disclosure also include a server apparatus. The server apparatus may include a memory storing digital content posted to an online social media platform comprising a plurality of digital posts associated with a first user and a processor executing a process. The process may include extracting a first content feature from a first digital post to an online social media platform selected from a plurality of digital posts, extracting a second content feature from a second digital post to an online social media platform selected from the plurality of social media posts, aggregating the first and second content features, inferring at least one of a frequency and a regularity of visits to a venue category associated with the plurality of digital posts based on the aggregated first and second content features using a neural network, and determining at least one of a frequently visited venue category and a regularly visited venue category based on the inferred frequency and a regularity of visits associated with the plurality of digital posts.

Still further aspects of the present application also include another server apparatus. The server apparatus may include means for extracting a first content feature from a first digital post to an online social media platform selected from a plurality of digital posts, means for extracting a second content feature from a second digital post to an online social media platform selected from the plurality of social media posts, means for aggregating the first and second content features, means for inferring at least one of a frequency and a regularity of visits to a venue category associated with the plurality of digital posts based on the aggregated first and second content features using a neural network, and means for determining at least one of a frequently visited venue category and a regularly visited venue category based on the inferred frequency and a regularity of visits associated with the plurality of digital posts.

### BRIEF DESCRIPTION OF THE DRAWINGS

FIG. 1 is a conceptual illustration of the input and output of a user visit behavior analysis system associated with an example implementation.

FIG. 2 illustrates a flowchart of a process of generating a predictive model of visits to venue categories performed by a behavior analysis system according to an example implementation.

FIGS. 3A and 3B illustrate a flowchart of another process of generating a predictive model of categories of visits to venue categories performed by a behavior analysis system according to an example implementation.

FIG. 4 illustrates a flowchart of a training process of generating labels and training a neural network that may be used in example implementations.

FIG. 5 illustrates a flow diagram of a baseline two-stage framework comparative example.

FIG. 6 illustrates the flow diagram of a single stage aggregating system according to an example implementation.

FIG. 7 illustrates an example environment suitable for some example implementations.

FIG. 8 illustrates an example computing environment with an example computer device suitable for use in some example implementations.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or operator control over certain aspects of the implementation, depending on the desired implementation of one of ordinary skill in the art practicing implementations of the present application.

With increased availability of mobile communication device access, social media use has shifted as more users access social media platforms via a mobile device. As users share locations and venues they travel to or visit on social media, social media posts may be a resource to learn the user's venue visit behavior. Example implementations may allow the analysis and prediction of a user's visit behavior (e.g., frequency and regularity with which the user visits certain venue categories) by using the user-contributed social media content. For example, an implementation may include a system that relies on generally available user-contributed content (e.g., image posts, video posts, text posts, and/or audio posts), rather than, or in addition to, location check-in data. Based on the user-contributed content, an example implementation may infer a likely visit pattern of the user associated with the posted content. As discussed above, user check-in data is less available than other user-contributed content (e.g., image posts, video posts, text posts, and/or audio posts) because check-in data is not as commonly used by users and is more tightly controlled by many social media users. Thus, image posts, video posts, text posts, and/or audio posts are more available than check-in data and example implementations may allow a wider coverage of users.

The inferred likely visit patterns obtained from online social media posts may be helpful to business managers by helping to understand their customer's venue category visit behavior and better target customers online. For example, a business manager may send relevant coupons of the businesses through social media networks or direct digital communication to the customers that visit business locations or real-world stores frequently, offering digital discounts periodically for the users who visit locations or stores regularly, or providing targeted information to users online that visit similar venue locations or stores (e.g., other business locations in the same venue category, such as competitors).

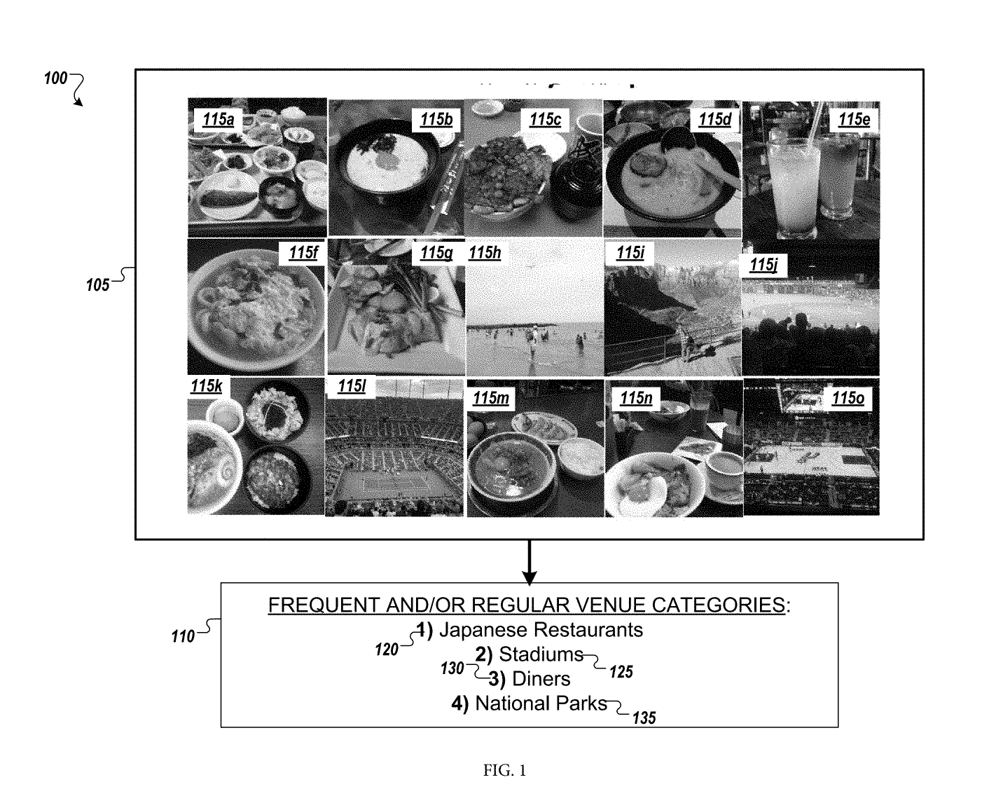

FIG. 1 is a conceptual illustration 100 of the input 105 and output 110 of a user visit behavior analysis system associated with an example implementation. The input 105 includes a sequence of a user's (User A) social media posts 115a-115o (e.g., digital posts) to an online social media platform. In FIG. 1, the multiple social media posts 115a-115o are illustrated as image posts. However, example implementations are not limited to this configuration and the social media posts may include text posts, video posts, audio posts, or any other post that may be apparent to a person of ordinary skill in the art. Additionally, the social media platform is not particularly limited and may be any social media platform that may be apparent to a person of ordinary skill in the art. For example, the social media platform may be a social networking platform, a professional networking platform, a media sharing platform, a microblogging platform, or any other social media platform that may be apparent to a person of ordinary skill in the art.

In an example implementation, the content of the social media posts 115a-115o is analyzed as discussed in greater detail below. Based on the analyzed content, venue categories 120-135 that User A is likely to visit regularly and/or frequently are inferred by the user visit behavior analysis system. For example, posts 15a-115d, 115f, 115k, 115m and 115n may be used to infer that User A regularly and/or frequently visits places in venue category 120 (e.g., Japanese restaurants). Further, posts 115j, 115l, and 115o may be used to infer that User A regularly and/or frequently visits places in venue category 125 (e.g., stadiums). Additionally, posts 115e and 115g may be used to infer that User A regularly and/or frequently visits places in venue category 130 (e.g., diners). Further, post 115i may be used to infer that User A regularly and/or frequently visits places in venue category 135 (e.g., national parks).

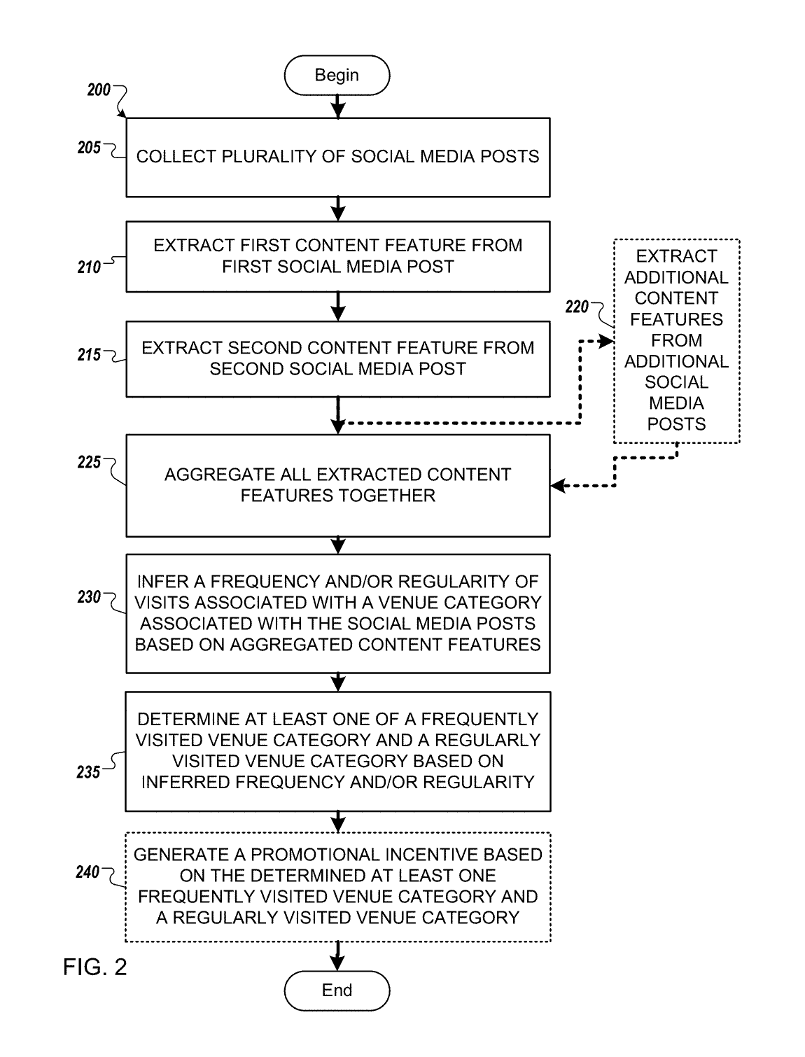

FIG. 2 illustrates a flowchart of a process 200 of generating a predictive model of visits to venue categories performed by a behavior analysis system according to an example implementation. In the process 200, a plurality of social media posts (e.g., digital posts to an online social media platform) associated with a specific user (e.g., “User A”) are collected at 205. The social media posts associated with User A may be collected from a single online social media platform or across different online social media platforms. In some example implementations, the plurality of collected posts may be publicly accessible posts or posts to which User A has granted access. Using only social media posts User A has made publicly accessible, or to which User A has granted access, may allow User A to control the content used to infer the user's venue category visit behavior.

The collected social media posts include text posts, image posts, video posts, audio posts, or any other post that may be apparent to a person of ordinary skill in the art. Additionally, the social media platform or social media platforms from which the posts are collected is not particularly limited and may be any social media platform that may be apparent to a person of ordinary skill in the art. For example, the social media platform may be a social networking platform, a professional networking platform, a media sharing platform, a microblogging platform, or any other social media platform that may be apparent to a person of ordinary skill in the art.

In some example implementations, the collected social media posts may optionally be sorted or grouped into batches based on time data associated with each social media post. For example, the collected social media posts may be grouped into weekly, monthly, or yearly batches.

After the plurality of social media posts are collected, at least one content feature is extracted from a first social media post at 210 using known computer-based content recognition techniques. For example, if the first social media post is an image post or video post, object recognition techniques may be applied to the image or video by one or more computing devices to identify the content of the post and extract one or more content features. Similarly, if the first social media post is a text post, text recognition techniques may be used by one or more computing devices to determine the subject matter or content of the post and extract one or more content features. Further, if the first social media post is an audio post then audio recognition, or voice recognition, techniques may be used by one or more computing devices to determine the content of the post and extract one or more content features. Additionally, if the first social media post is a multi-modal content post containing a combination of one or more of audio, video, image, or text information, each type of information may be processed using one or more content recognition processes that may be apparent to a person of ordinary skill in the art. In some example implementations, the one or more computing devices performing the content recognition processes may be a neural network such as a Convolutional Neural Network (CNN).

After at least one content feature is extracted from the first social media post at 210, at least one content feature may be extracted from a second social media post at 215 using known computer-based content recognition techniques. For example, if the second social media post is an image post or video post, object recognition techniques may be applied to the image or video by one or more computing devices to identify the content of the post and extract one or more content features. Similarly, if the second social media post is a text post, text recognition techniques may be used by one or more computing devices to determine the subject matter or content of the post and extract one or more content features. Further, if the second social media post is an audio post, then audio recognition, or voice recognition, techniques may be used by one or more computing devices to determine the content of the post and extract one or more content features. Additionally, if the second social media post is a multi-modal content post containing a combination of one or more of audio, video, image, or text information, each type of information may be processed using one or more content recognition processes that may be apparent to a person of ordinary skill in the art. In some example implementations, the one or more computing devices performing the content recognition processes may be a neural network such as a Convolutional Neural Network (CNN) may be used to extract the one or more content features from the second social media post.

In some example implementations, additional content features may optionally be extracted from additional social media posts (e.g., a third social media post, a fourth social media post, etc.) at 220 using techniques similar to those discussed above with respect to 210 and 215.

After the content features have been extracted, the extracted content features are aggregated to create an aggregated collection of content features associated with the user at 225 using a neural network based on prior learned or pre-defined relationships between content features. For example, the neural network may take an average of the content feature value or perform convolution over the content feature value extracted in subsequences of posts based on trained or predefined relationships.

The aggregated collection may include all content features extracted from the social media posts as well as a frequency or regularity associated with any content features are repeated in different social media posts. For example, if a content feature indicative of specific semantics (e.g., hamburger) is extracted from multiple social media posts, the number of different posts associated with the content feature indicative of the specific venue category (e.g., fast food restaurant) may be tracked as an indication of frequency of posting content related to that content feature indicative of the specific venue category (e.g., fast food restaurant). Additionally, a variance of time intervals between any two consecutive posts associated with the content feature indicative of the specific venue category (e.g., fast food restaurant) may also be tracked and used to determine a regularity of posts associated with the content feature indicative of specific venue category (e.g., fast food restaurant). For example, if the variance of time intervals between posts related to fast food restaurant is smaller than the variance of time intervals between posts related to Japanese restaurant, the regularity of fast food restaurant may be higher than that of Japanese restaurant.

In some example implementations of the process 200, aggregating content features together (as is done at 225) prior to attempting to infer a frequency or regularity of venue category (as discussed below at 230) associated with social media may provide greater reliability compared to attempting to infer a venue category based on individual social media posts.

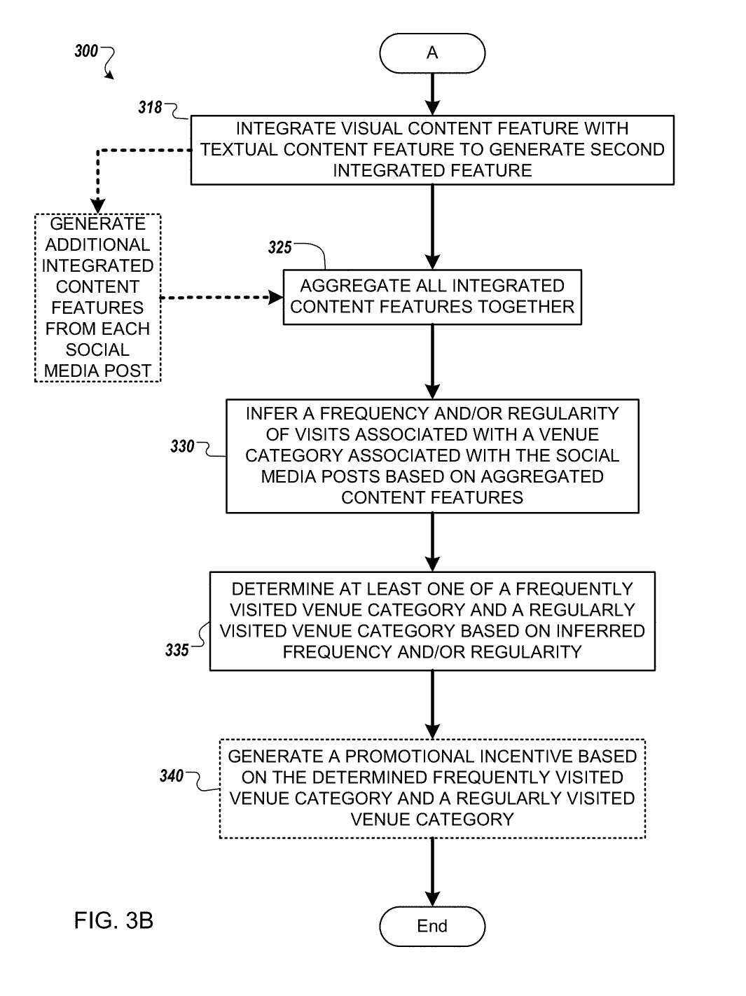

Based on the aggregated content features, the neural network may infer a frequency or regularity with which User A may visit one or more venue categories at 230 to generate a predictive model of visits to venue categories. In order to infer the frequency or regularity, the neural network may be trained using a training process, such as the training process 400 described with respect to FIG. 4 discussed below. During the training process, the neural network may be trained using social media posts from multiple users to develop or learn relationships between content features extracted from social media posts and venue categories. Based on the developed or learned relationships of the training process and the aggregated content features associated with User A, the neural network may infer frequency or regularity that User A visits different venue categories. For example, the neural network may be used to determine likely venue categories associated with the aggregated extracted content features based on the developed or learned relationships created using the process 400 of FIG. 4. Further, the frequency or regularity of social media posts from which the aggregated content features were extracted may be used by the neural network to infer a frequency or regularity of visits to the venue categories associated with the aggregated content features.

In some example implementations, changes in frequency or regularity may also be inferred based on the batches the social media posts were sorted or grouped into. For example, if the collected social media posts were grouped into monthly or yearly batches, changes in the frequency or regularity inferred for certain venue categories may vary between monthly or yearly batches, indicating a potential change in frequency or regularity month to month or year to year.

At 235, at least one frequently or regularly visited venue category may be determined based on the inferred frequency or regularity exceeding a threshold value. The threshold value may be set by a system administrator associated with the social media platform in some example implementations. In other example implementations, the threshold value may be set by a business manager associated with a venue within one of the venue categories. In still other example implementations, the threshold value may be set dynamically based on the determined frequency or regularity of visits inferred by the user visit behavior analysis system.

After at least one frequently or regularly visited venue category is determined, a digital communication containing a promotional incentive may optionally be generated and transmitted to User A at 240. For example, a coupon for a venue within the determined venue category may be generated and transmitted to User A via a social media platform or via communication information provided by User A (e.g., an Short Message Service (SMS) message sent to a provided mobile phone number, an email sent to a provided email address, etc.). As another example, a notification of an upcoming sale or special at a venue within the determined venue category may be sent to User A. As a third example, suggestions of other venue categories related to the determined venue category may also be sent to User A. After the promotion incentive has been generated, the process 200 may terminate.

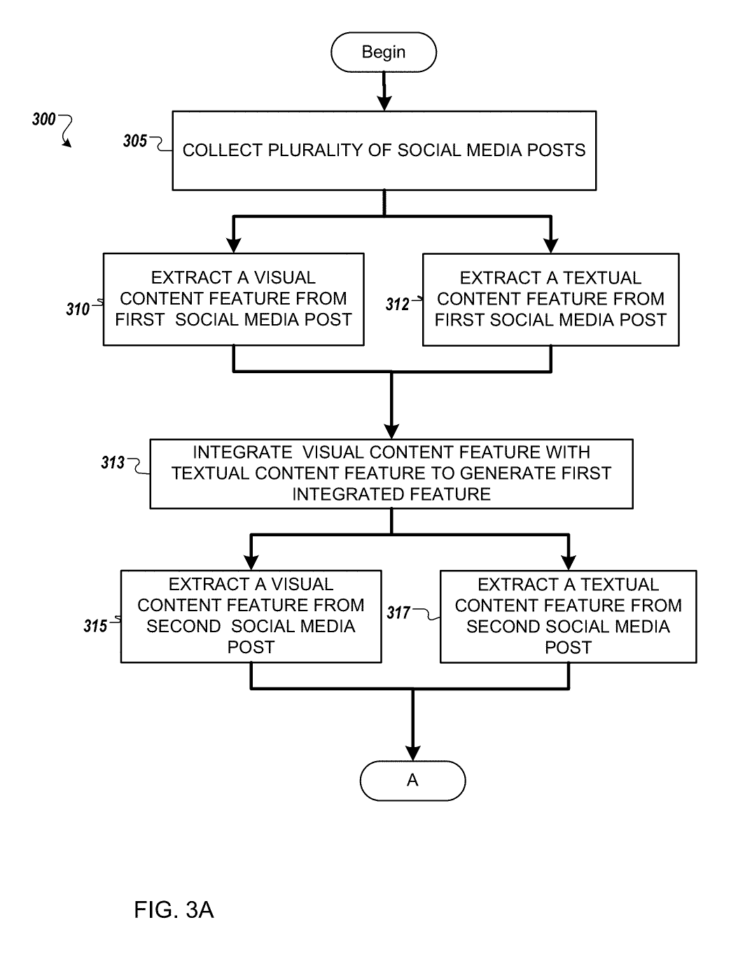

FIGS. 3A and 3B illustrate a flowchart of another process of generating a predictive model of categories of visits to venue categories performed by a behavior analysis system according to an example implementation. Some aspects of the process 300 may be similar to aspects of the process 200 illustrated in FIG. 2. In the process 300, a plurality of social media posts (e.g., digital posts to an online social media platform) associated with a specific user (e.g., “User A”) are collected at 305. Again, the social media posts associated with User A may be collected from a single online social media platform or across different online social media platforms. In some example implementations, the plurality of collected posts may be publicly accessible posts or posts to which User A has granted access. Using only social media posts User A has made publicly accessible, or to which User A has granted access, may allow User A to control the content used to infer the user's venue category visit behavior.

The collected social media posts include text posts, image posts, video posts, audio posts, or any other post that may be apparent to a person of ordinary skill in the art. Additionally, the social media platform or social media platforms from which the posts are collected is not particularly limited and may be any social media platform that may be apparent to a person of ordinary skill in the art. For example, the social media platform may be a social networking platform, a professional networking platform, a media sharing platform, a microblogging platform, or any other social media platform that may be apparent to a person of ordinary skill in the art.

In some example implementations, the collected social media posts may optionally be sorted or grouped into batches based on time data associated with each social media post. For example, the collected social media posts may be grouped into weekly, monthly, or yearly batches.

After the plurality of social media posts are collected, at least one visual content feature is extracted from a first social media post at 310 using known computer-based content recognition techniques. For example, if the first social media post is an image post or video post, object recognition techniques may be applied to the image or video by one or more computing devices to identify the content of the post and extract one or more image content features. In some example implementations, the one or more computing devices performing the content recognition processes may be a neural network such as a Convolutional Neural Network (CNN).

Further, at least one textual content feature may also be extracted from the first social media post at 312 using known computer-based content recognition techniques. For example, text displayed in the image or video of the first social media post may be extracted by one or more computing devices using text recognition techniques to determine the subject matter or content of the post and extract one or more content features. Additionally, captions or textual tags associated with the first social media post may also be processed by one or more computing devices using text recognition techniques to determine the at least one textual content feature. Further, if the first social media post contains audio data then audio recognition, or voice recognition, techniques may be used by one or more computing devices to convert the audio data to text and extract one or more textual content features. Again, in some example implementations, the one or more computing devices performing the content recognition processes may be a neural network such as a Convolutional Neural Network (CNN).

In some example implementations, the at least one textual content feature may be extracted from the first social media post after the at least one visual content feature is extracted from the first social media post. In other example implementations, the at least one textual content feature may be extracted from the first social media post before, or at the same time that, the at least one visual content feature is extracted from the first social media post.

After both the at least one image content feature and the at least one textual content feature is extracted from the first social media post, the at least one image content feature and the at least one textual content feature are integrated at 313 using a neural network to generate at least a first integrated content feature. For example, the neural network may project the at least one image content feature and the at least one textual content feature to a common feature representation space, to get the same form of feature representation from the image and text associated with the first social media post. The transformed feature representation from image and the transformed feature representation from text may be integrated by concatenation, averaging, etc.

After at least one integrated content feature is generated from the first social media post, at least one visual content feature is extracted from a second social media post at 315 using known computer-based content recognition techniques. For example, if the second social media post is an image post or video post, object recognition techniques may be applied to the image or video by one or more computing devices to identify the content of the post and extract one or more image content features. In some example implementations, the one or more computing devices performing the content recognition processes may be a neural network such as a Convolutional Neural Network (CNN).

Further, at least one textual content feature may also be extracted from the second social media post at 317 using known computer-based content recognition techniques. For example, text displayed in the image or video of the second social media post may be extracted by one or more computing devices using text recognition techniques to determine the subject matter or content of the post and extract one or more content features. Additionally, captions or textual tags associated with the second social media post may also be processed by one or more computing devices using text recognition techniques to determine the at least one textual content feature. Further, if the second social media post contains audio data then audio recognition, or voice recognition, techniques may be used by one or more computing devices to convert the audio data to text and extract one or more textual content features. Again, in some example implementations, the one or more computing devices performing the content recognition processes may be a neural network such as a Convolutional Neural Network (CNN).

In some example implementations, the at least one textual content feature may be extracted from the second social media post after the at least one visual content feature is extracted from the second social media post. In other example implementations, the at least one textual content feature may be extracted from the second social media post before, or at the same time that, the at least one visual content feature is extracted from the second social media post.

After both the at least one image content feature and the at least one textual content feature is extracted from the second social media post, the at least one image content feature and the at least one textual content feature are integrated at 318 to generate at least a second integrated content feature. For example, the neural network may project the at least one image content feature and the at least one textual content feature to a common feature representation space, to get the same form of feature representation from the image and text associated with the second social media post. The transformed feature representation from image and the transformed feature representation from text may be integrated by concatenation, averaging, etc.

In some example implementations, additional content features may optionally be extracted from additional social media posts (e.g., a third social media post, a fourth social media post, etc.) at 320 by repeating the techniques discussed above with respect by 310-313 and 315-318.

After the integrated content features have been generated, the integrated content features are aggregated to create an aggregated collection of content features associated with the user at 325 using a neural network based on prior learned or pre-defined relationships between content features. For example, the neural network may take an average of the content feature value or perform convolution over the content feature value extracted in subsequences of posts based on trained or predefined relationships.

The aggregated collection may include all integrated content features generated from the visual and textual content features extracted from the social media posts as well as a frequency or regularity associated with any content features repeated in different social media posts. For example, if a content feature indicative of a specific venue category (e.g., fast food restaurant) is extracted from multiple social media posts, the number of different posts associated with the content feature indicative of the specific venue category (e.g., fast food restaurant) may be tracked as an indication of frequency of posting content related to that content feature indicative of the specific venue category (e.g., fast food restaurant). Additionally, a variance of time intervals between any two consecutive posts associated with the content feature indicative of the specific venue category (e.g., fast food restaurant) may also be tracked and used to determine a regularity of posts associated with the content feature indicative of the specific venue category (e.g., fast food restaurant). For example, if the variance of time intervals between posts related to fast food restaurant is smaller than the variance of time intervals between posts related to Japanese restaurant, the regularity of fast food restaurant may be higher than that of Japanese restaurant

In some example implementations of the process 300, aggregating content features together (as is done at 325) prior to attempting to inferring a frequency or regularity of venue category (as discussed below at 330) associated with social media may provide greater reliability compared to attempting to infer a venue category based on individual social media posts.

Based on the aggregated content features, the neural network may infer a frequency or regularity with which User A may visit one or more venue categories at 330 to generate a predictive model of visits to venue categories. In order to infer the frequency or regularity, the neural network may be trained using a training process, such as the training process described with respect to FIG. 4 discussed below. During the training process, the neural network may be trained using social media posts from multiple users to develop associations between content features social media posts and venue categories. Based on the developed or learned relationships of the training process and the aggregated content features associated with User A, the neural network may infer frequency or regularity that User A visits different venue categories. For example, the neural network may be used to determine likely venue categories associated with the aggregated extracted content features based on the developed or learned relationships created using the process 400 of FIG. 4. Further, the frequency or regularity of social media posts from which the aggregated content features were extracted may be used by the neural network to infer a frequency or regularity of visits to the venue categories associated with the aggregated content features.

In some example implementations, changes in frequency or regularity may also be inferred based on the batches the social media posts were sorted or grouped into. For example, if the collected social media posts were grouped into monthly or yearly batches, changes in the frequency or regularity inferred for certain venue categories may vary between monthly or yearly batches, indicating a potential change in frequency or regularity month to month or year to year.

At 335, at least one frequently or regularly visited venue category may be determined based on the inferred frequency or regularity exceeding a threshold value. The threshold value may be set by a system administrator associated with the social media platform in some example implementations. In other example implementations, the threshold value may be set by a business manager associated with a venue within one of the venue categories.

After at least one frequently or regularly visited venue category is determined, a digital communication containing a promotional incentive may optionally be generated and transmitted to User A at 340. For example, a coupon for a venue within the determined venue category may be generated and transmitted to User A via a social media platform or via communication information provided by User A (e.g., an SMS message sent to a provided mobile phone number, an email sent to a provided email address, etc.). As another example, a notification of an upcoming sale or special at a venue within the determined venue category may be sent to User A. As a third example, suggestions of other venue categories related to the determined venue category may also be sent to User A. After the promotion incentive has been generated, the process 300 may terminate.

FIG. 4 illustrates a flowchart of a training process 400 of generating labels and training a neural network that may be used in the processes 200 and 300 according to example implementations of the present application. In the process 400, a plurality of social media posts (e.g., digital posts to an online social media platform) associated with from multiple users are collected at 405. Again, the social media posts associated with the multiple users may be collected from a single online social media platform or across different online social media platforms. In some example implementations, the plurality of collected posts may be publicly accessible posts or posts that the users have granted access to. Only social media posts that have been made publicly accessible, or which access has been granted may be used in example implementations so that the users may control the content being used to train the neural network.

The collected social media posts include text posts, image posts, video posts, audio posts, or any other post that may be apparent to a person of ordinary skill in the art. Additionally, the social media platform or social media platforms from which the posts are collected is not particularly limited and may be any social media platform that may be apparent to a person of ordinary skill in the art. For example, the social media platform may be a social networking platform, a professional networking platform, a media sharing platform, a microblogging platform, or any other social media platform that may be apparent to a person of ordinary skill in the art.

After the plurality of social media posts are collected, at least one content feature is extracted from each social media post at 410. In some example implementations, each social media post may be processed with one or more content recognition techniques. For example, if a social media post is an image post or video post, object recognition techniques may be applied to the image or video to identify the content of the post and extract one or more content features. Similarly, if a social media post is a text post, text recognition techniques may be used to determine the subject matter or content of the post and extract one or more content features. Further, if a social media post is an audio post, audio recognition, or voice recognition techniques may be used to determine the content of the post and extract one or more content features. In some example implementations, a neural network such as a Convolutional Neural Network (CNN) may be used to extract the one or more content features from the social media post.

In addition to extracting at least one content feature from each social media post, metadata associated with each social media post is extracted at 415. In some example implementations, the extracted metadata may be location metadata. The extraction of the location metadata may be done before the content features are extracted from the social media posts, after the content features are extracted from the social media posts, or in parallel with the extraction of the content features from social media posts. The location metadata may be Global Positioning System (GPS) data, geotag data, user check-in data (e.g., data associated with a specific social media post where the user has selected the venue from a list of known or previously identified venues, and actively indicated that the user was physically at the venue at specific time or on a specific date), or any other metadata indicative of a location associated with each social media post. In some example implementations, the extracted metadata may also be time data indicating when the social media post was captured, created, authored, or posted to the social media network.

Based on the extracted metadata, a venue category label associated with each social media post is determined at 420. In some example implementations, the venue category label may be determined by consulting one or more public databases of venue categories associated with specific venues or locations. In other example implementations, the venue category label may use other techniques of associated a venue category label with an identified location. For example, techniques illustrated in U.S. Patent Publication 2016/0110381 may be used to associate the venue category with the extracted metadata.

Additionally, in some example implementations, determining the venue category label associated with each social media post contributed by a user may be used to generate ground-truth labels associated with the user, each label indicating the frequency and/or regularity of a venue category associated with location metadata extracted from the user's social media posts where the frequency and regularity are derived from timestamp metadata of each post associated with the determined venue category in the user's sequence, and these rules may be used to optimize parameters of a predictor model. Further, optimization of the predictor model may be discussed in greater detail below.

After the venue category label associated with each social media post is determined, each determined venue category is associated with the at least one content feature extracted from each social media post at 425. Alternatively, after the ground-truth labels associated with each user are determined, the determined ground-truth labels are associated with the at least one content feature extracted from each sequence of social media posts contributed by a user at 425.

At 430, one or more parameters of a predictor model may be optimized based on the association between each determined venue category and the at least one content feature extracted from each social media post. In some example implementations, a predictor model may be optimized based on the association between the determined ground-truth labels and the at least one content feature extracted from each sequence of social media posts contributed by a user. The predictor model may be designed to generate a probability vector based on a sequence of social media posts contributed by a user. The probability vector may be a stochastic vector made of up of a plurality of non-negative elements that add up to 1. Within the probability vector, each element indicates how likely the user would be visit a venue category frequently and/or regularly based on the associations between the content features extracted from the social media posts and venue categories. After the predictor model has been optimized, the training process 400 may end.

Evaluation Results

Example implementations were evaluated by experimentation. The experiments are conducted using on a data set that included geo-tagged microblog posts around the San Francisco Bay Area dating from June 2013 to April 2014. The experimental dataset included 178,736 images each associated a venue category. From the dataset, 9,534 sequences of images from users were extracted to use for training and test data of user's frequent and regular venue category prediction. In the preliminary evaluation, the experiments were conducted on images only, but a similar framework for texts could be used.

During the training phase, a ground-truth probability (prob_{c}) of each venue category (c) may be calculated. The ground-truth probability (prob_{c}) considers both frequency and regularity, and is derived from the venue category and the time stamp associated with each image (i) of a given user's image sequence.

prob_{c}=score_{c}/sum(scoreᵢ), for all i in C, wherein (eq. 1)

score_{c}=f_{c}×(d_{c}+α)/(sqrt(var(ΔT_{c}))+α), and (eq. 2)

f is the frequency of posts and ΔT_{c} is a set of time intervals between any two consecutive posts related to the venue category c. Further, d_{c} is the time duration between a first post and a last post and a is a constant value (0.3 in the experiments). C is the whole set of venue categories.

During the test phase, the system takes a given user's image sequence as the input. In the preliminary test, focus was placed on 164 more common and visually consistent venue categories for the experiments. Table 1 illustrates a selection of example categories in the experiments. Other venue categories may be apparent to a person of ordinary skill in the art.

TABLE 1
Example Venue Categories

Beach, Movie Theater, Stadium, Ski Area,
Trail, Winery, Bookstore, Salon, Airport,
Jewelry Store, Ice Cream Shop, Bar, Car Wash,
Casino, Campground, Food Truck, Theme
Park, Pet Service, Zoo, . . .

The training process could be based on various machine-learning frameworks, but based on one of several series of Neural Networks architectures. Different Convolutional Neural Network architectures were compared to select the most suitable one for the task. Each CNN architecture was trained from the ImageNet dataset (a million-scale image database) and fine-tuned using the images associated with venue categories. Venue category prediction for single images was then performed to evaluate the classification accuracy and training time cost of each CNN architecture. The results are presented in Table 2 below.

TABLE 2
CNN Prediction Accuracy and Training Time Costs

| Models for | | | |
|---|---|---|---|
| CNN | AlexNet | VGGNet | ResNet |
| Classification | 37.4 | 37.94 | 38.9 |
| Accuracy (%) | | | |
| Approximate | 2 | 4 | 5 |
| Time Costs | | | |
| (Days) | | | |

After the comparison, AlexNet was selected because it has much faster training time than VGGNet and ResNet while having competitive classification accuracy.

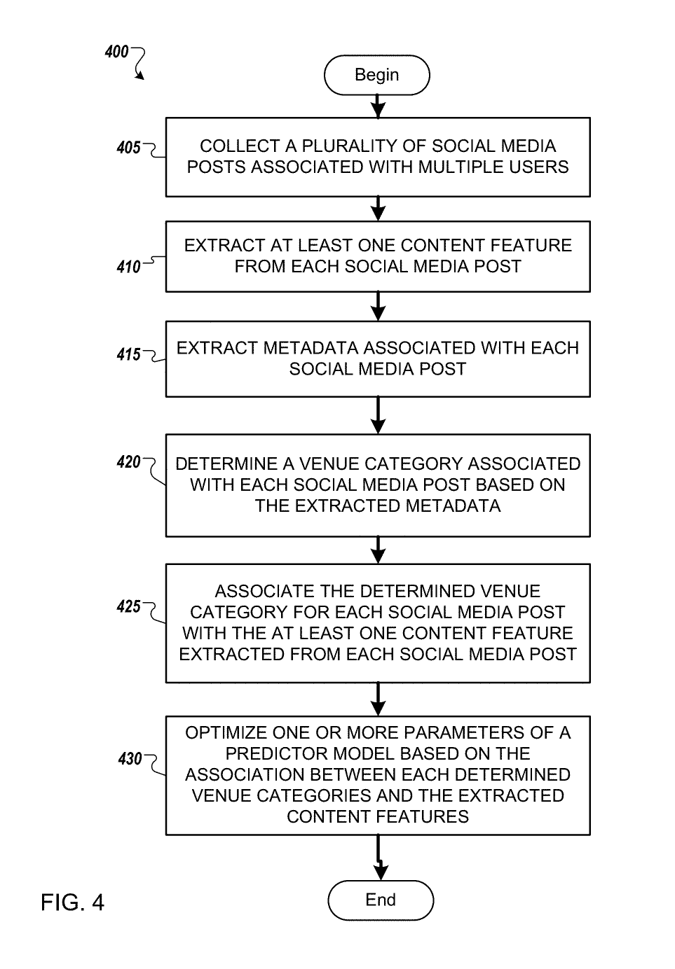

For user-level venue category prediction, a single stage aggregating system (MIL) according to example implementations was compared to a baseline two-stage framework (SIL). FIG. 5 illustrates a flow diagram 500 of the baseline two-stage framework (SIL). As illustrated, the two stage framework SIL involves first location prediction based on content features of individual images at 505 and aggregating or pooling the prediction results at 510. Based on the aggregated or pooled prediction results of 510, a user label is generated at 515.

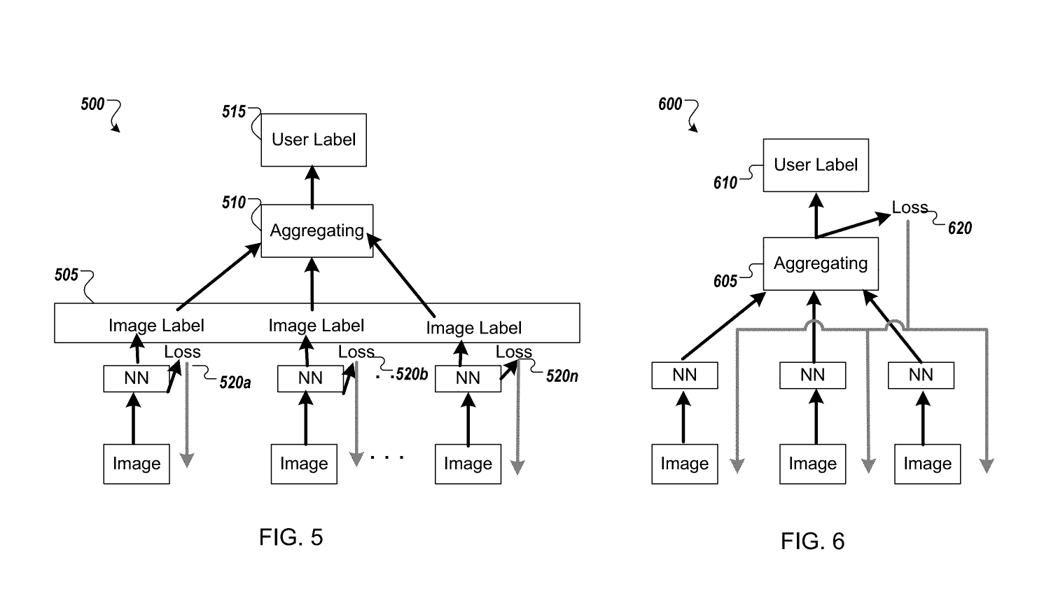

Conversely, FIG. 6 illustrates the flow diagram 600 of the single stage aggregating system (MIL) according to the Example implementation. As illustrated, image labels are not generated based on content features of single images in MIL. Instead, as discussed above, content features from the single images are pooled or integrated by convolution at 605 and a user label is generated at 610.

To compare the two frameworks (SIL vs. MIL), two different loss functions were implemented to catch the classification loss and ranking loss. The two variants of the proposed example implementations are denoted as MIL Classification and MIL Ranking in Table 3, respectively. Additionally, there are two pooling strategies, max pooling, and average pooling, commonly used in CNN. Both pooling strategies were compared in the experiments. The average pooling outperforms max pooling in our task, either used in the baseline SIL or the proposed MIL.

TABLE 3
Prediction of user's frequent and regular categories.

| | SIL | SIL | MIL | MIL | | |
|---|---|---|---|---|---|---|
| Evaluation | (Max | (Average | Classification | Classification | MIL | MIL + FC |
| Metric (%) | Pooling) | Pooling) | (Max Pooling) | (Average Pooling) | Ranking | Ranking |
| Classification | 25.2 | 34.6 | 33.9 | 36.4 | 36.0 | 36.0 |
| Accuracy | | | | | | |
| Ranking | 34.94 | 46.16 | 45.42 | 47.84 | 48.45 | 48.23 |
| Quality | | | | | | |
| nDCCG1 | | | | | | |
| Ranking | 43.54 | 54.41 | 45.40 | 53.30 | 55.29 | 55.78 |
| Quality | | | | | | |
| nDCCG3 | | | | | | |
| Ranking | 47.52 | 56.43 | 47.82 | 55.30 | 57.59 | 57.80 |
| Quality | | | | | | |
| nDCCG5 | | | | | | |

As illustrated in Table 3, most of the MIL models perform substantially differently from the baseline SIL in terms of classification accuracy and ranking quality. Using MIL Classification may produce substantially different classification accuracy while using MIL Ranking may obtain substantially differently ranking result for user's frequent and regular venue categories. The two different models could be used for different applications, e.g., MIL Ranking would be a substantially different option for providing a list of prioritized recommendations, and MIL Classification can help target users of a specific category. With an additional fully connected layer on top of MIL (MIL+FC), the ranking quality could be further changed.

As these comparisons illustrate, venue category prediction usually has less complexity of prediction compared to location prediction (e.g., predicting based on rough GPS or exact business venue name), because venue category is a superset of venues and the number of classes is generally smaller. For example, the number of venues (e.g., PEET'S, STARBUCKS, PHILZ, BLUE BOTTLE, etc.) is much larger than the number of venue categories (e.g., café). Moreover, compared to location prediction, venue category often has higher relevance with user-contributed content because the venue categories are categorized by user activities at venues. This nature may make it more intuitive to use user-contributed content for inferring user's visit behavior. Further, an example implementation of the present application may prevent propagation of error or loss (620 in FIG. 6) compared to a multiple-stage framework, which may introduce error with every image (520a-520n in FIG. 5).

### Example Environment

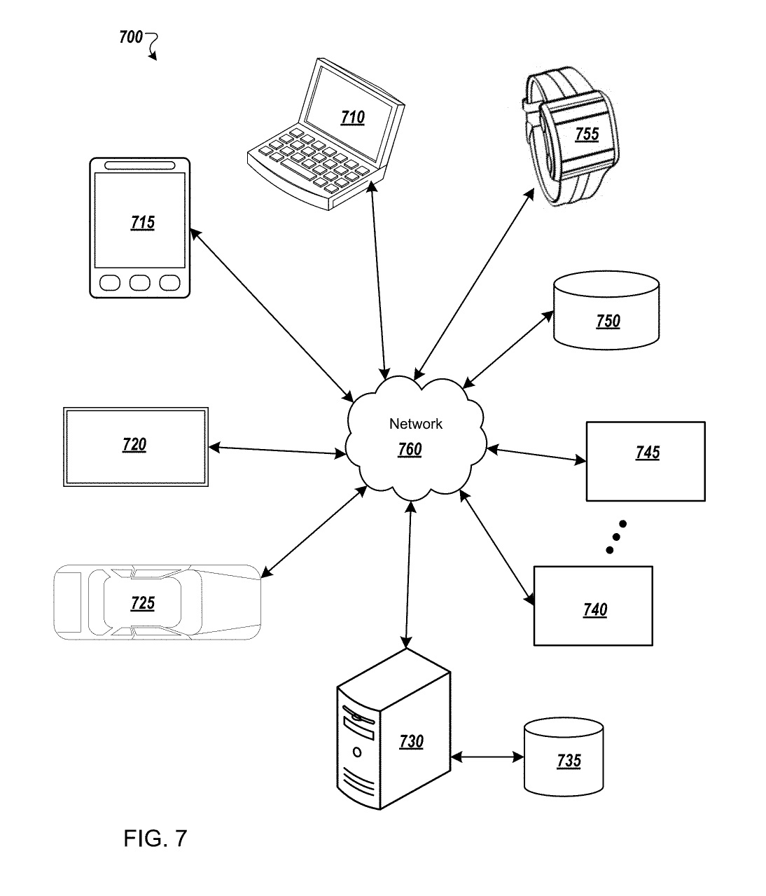

FIG. 7 illustrates an example environment 700 suitable for some example implementations. Environment 700 includes devices 710-755, and each is communicatively connected to at least one other device via, for example, network 760 (e.g., by wired and/or wireless connections). Some devices 730 may be communicatively connected to one or more storage devices 735 and 750.

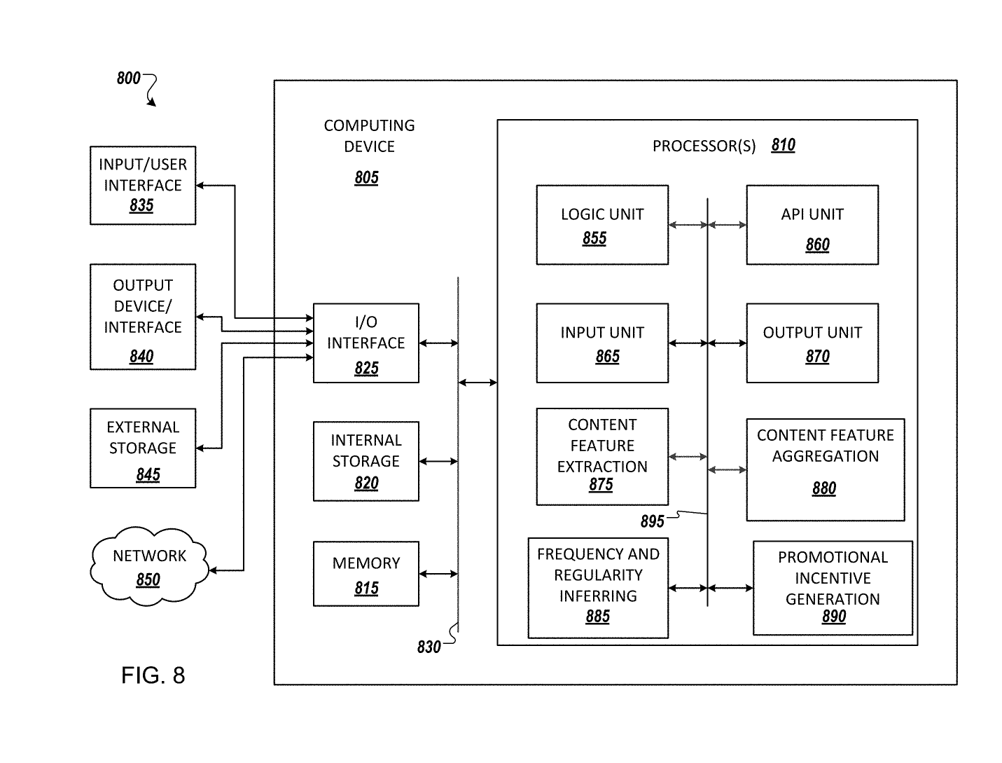

An example of one or more devices 710-755 may be a computing device 805 described below in FIG. 8. Devices 710-755 may include, but are not limited to, a computer 710 (e.g., a laptop computing device), a mobile device 715 (e.g., smartphone or tablet), a television 720, a device associated with a vehicle 725, a server computer 730, computing devices 740-745, storage devices 735 and 750 and wearable device 755.

In some implementations, devices 710-725 and 755 may be considered user devices (e.g., devices used by users to access a social media platform and post or share content such as images, text, video, audio, etc.). Devices 730-750 may be devices associated with a business management system and may be used to infer frequency or regularity of user visits to venue categories. For example, the devices 730-750 may be behavior analysis systems that perform the processes 200/300 of FIGS. 2 and 3 by collecting the social media postings associated with individual users, extracting content features, aggregating the content features together and inferring frequency or regularity with which the user associated with the social media postings visit different categories of venues.

### Example Computing Environment

FIG. 8 illustrates an example computing environment 800 with an example computing device 805 suitable for use in some example implementations. The computing device 805 may be part of a behavior analysis system and be used to perform the processes 200/300 of FIGS. 2 and 3. The computing device 805 in computing environment 800 can include one or more processing units, cores, or processors 810, memory 815 (e.g., RAM, ROM, and/or the like), internal storage 820 (e.g., magnetic, optical, solid state storage, and/or organic), and/or I/O interface 825, any of which can be coupled on a communication mechanism or bus 830 for communicating information or embedded in the computing device 805.

Computing device 805 can be communicatively coupled to input/user interface 835 and output device/interface 840. Either one or both of input/user interface 835 and output device/interface 840 can be a wired or wireless interface and can be detachable. Input/user interface 835 may include any device, component, sensor, or interface, physical or virtual, which can be used to provide input (e.g., buttons, touch-screen interface, keyboard, a pointing/cursor control, microphone, camera, braille, motion sensor, optical reader, and/or the like). Output device/interface 840 may include a display, television, monitor, printer, speaker, braille, or the like. In some example implementations, input/user interface 835 and output device/interface 840 can be embedded with or physically coupled to the computing device 805. In other example implementations, other computing devices may function as or provide the functions of input/user interface 835 and output device/interface 840 for a computing device 805.

Examples of computing device 805 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, server devices, other computers, information kiosks, televisions with one or more processors embedded therein and/or coupled thereto, radios, and the like).

Computing device 805 can be communicatively coupled (e.g., via I/O interface 825) to external storage 845 and network 850 for communicating with any number of networked components, devices, and systems, including one or more computing devices of the same or different configuration. Computing device 805 or any connected computing device can be functioning as, providing services of, or referred to as a server, client, thin server, general machine, special-purpose machine, or another label.

I/O interface 825 can include, but is not limited to, wired and/or wireless interfaces using any communication or I/O protocols or standards (e.g., Ethernet, 802.11x, Universal System Bus, WiMAX, modem, a cellular network protocol, and the like) for communicating information to and/or from at least all the connected components, devices, and network in computing environment 800. Network 850 can be any network or combination of networks (e.g., the Internet, local area network, wide area network, a telephonic network, a cellular network, satellite network, and the like).

Computing device 805 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 805 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 810 can execute under any operating system (OS) (not shown), in a native or virtual environment. One or more applications can be deployed that include logic unit 855, application programming interface (API) unit 860, input unit 865, output unit 870, content feature extraction 875, content feature aggregation unit 880, frequency and regularity inferring unit 885, promotional incentive generation unit 890, and inter-unit communication mechanism 895 for the different units to communicate with each other, with the OS, and with other applications (not shown). For example, content feature extraction 875, content feature aggregation unit 880, frequency and regularity inferring unit 885, promotional incentive generation unit 890 may implement one or more processes shown in FIGS. 2-4. The described units and elements can be varied in design, function, configuration, or implementation and are not limited to the descriptions provided.

In some example implementations, when information or an execution instruction is received by API unit 860, it may be communicated to one or more other units (e.g., logic unit 855, input unit 865, output unit 870, content feature extraction 875, content feature aggregation unit 880, frequency and regularity inferring unit 885, and promotional incentive generation unit 890). For example, when a plurality of social media posts are collected via the input unit 865, the content feature extraction unit 875 may analyze the post to extract one or more content features from each social media post. Additionally, the content feature aggregation unit 880 aggregates the content features extracted by the content feature extraction unit 875. Once the content feature aggregation unit 880 aggregates the content features extracted from each social media post, the frequency and regularity inferring unit 885 infers one or more of the frequency or regularity with which a user visits different venue categories. Based on the inferred one or more frequency or regularity inferred by the frequency and regularity inferring unit 885, the promotional incentive generation unit 890 may generate and transmit promotional incentives to a user using the output unit 870.

In some instances, the logic unit 855 may be configured to control the information flow among the units and direct the services provided by API unit 860, input unit 865, output unit 870, content feature extraction 875, content feature aggregation unit 880, frequency and regularity inferring unit 885, and promotional incentive generation unit 890 in some example implementations described above. For example, the flow of one or more processes or implementations may be controlled by logic unit 855 alone or in conjunction with API unit 860.

Although a few example implementations have been shown and described, these example implementations are provided to convey the subject matter described herein to people who are familiar with this field. It should be understood that the subject matter described herein may be implemented in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

What is claimed is:

1. A method of generating a predictive model of categories of venues visited by a user, the method comprising:
extracting a first content feature from a first digital post to an online social media platform selected from a plurality of digital posts;
extracting a second content feature from a second digital post to an online social media platform selected from the plurality of social media posts;
aggregating the first and second content features;
inferring at least one of a frequency and a regularity of visits to a venue category associated with the plurality of digital posts based on the aggregated first and second content features using a neural network; and
determining at least one of a frequently visited venue category and a regularly visited venue category based on the inferred frequency and a regularity of visits associated with the plurality of digital posts.

2. The method of claim 1, further comprising automatically generating a digital communication, and sending the digital communication to a first user associated with the plurality of digital posts to the online social media platform based on the determined one of a frequently visited venue category and a regularly visited venue category.

3. The method of claim 1, wherein the extracting the first content feature from the first digital post comprises extracting at least one of a first visual content feature and a first textual content feature from the first digital post; and
wherein the extracting the second content feature from the second digital post comprises extracting at least one of a second visual content feature and a second textual content feature from the second digital post.

4. The method of claim 1, wherein the extracting the first content feature from the first digital post comprises:
extracting both a first visual content feature and a first textual content feature from the first digital post; and
integrating the first visual content feature and the first textual content feature to generate a first integrated content feature;
wherein the extracting the second content feature from the second digital post comprises:
extracting both a second visual content feature and a second textual content feature from the second digital post; and
integrating the second visual content feature and the second textual content feature to generate a second integrated content feature; and
wherein aggregating the first content feature and the second content feature together comprises aggregating the first integrated content feature and the second integrated content feature.

5. The method of claim 1, further comprising training the neural network by:
extracting a content feature from each of a plurality of digital posts to an online social media platform associated with a plurality of users;
extracting metadata associated with each of the plurality of digital posts;
determining a venue category associated with each digital post based on the extracted metadata; and
optimizing one or more parameters of a predictor model based on an association between the determined venue category and the extracted content features; and
wherein the inferring at least one of a frequency and a regularity of visits to a venue category comprises inferring venue categories based on the aggregated first and second content features using the optimized predictor model.

6. The method of claim 5, wherein the extracted metadata comprises one or more of:
Global Positioning System (GPS) data, geotag data, and check-in data associated with each digital post.

7. The method of claim 1, further comprising sorting the plurality of digital posts into a first group of digital posts and a second group of digital post based on temporal data associated with each digital post; and
wherein the inferring at least one of a frequency and a regularity of visits to a venue category comprises:
inferring a first at least one of a frequency and a regularity of visits to a venue category associated with the first group of digital posts; and
inferring a second at least one of a frequency and a regularity of visits to a venue category associated with the second group of digital post.

8. A non-transitory computer readable medium having stored therein a program for making a computer execute a method of generating a predictive model of categories of venues visited by a user, the method comprising:
extracting a first content feature from a first digital post to an online social media platform selected from a plurality of digital posts;
extracting a second content feature from a second digital post to an online social media platform selected from the plurality of social media posts;
aggregating the first and second content features;
inferring at least one of a frequency and a regularity of visits to a venue category associated with the plurality of digital posts based on the aggregated first and second content features using a neural network; and
determining at least one of a frequently visited venue category and a regularly visited venue category based on the inferred frequency and a regularity of visits associated with the plurality of digital posts.

9. The non-transitory computer readable medium of claim 8, further comprising automatically generating a digital communication, and sending the digital communication to a first user associated with the plurality of digital posts to the online social media platform based on the determined one of a frequently visited venue category and a regularly visited venue category.

10. The non-transitory computer readable medium of claim 8, wherein the extracting the first content feature from the first digital post comprises extracting at least one of a first visual content feature and a first textual content feature from the first digital post; and
wherein the extracting the second content feature from the second digital post comprises extracting at least one of a second visual content feature and a second textual content feature from the second digital post.

11. The non-transitory computer readable medium of claim 8, wherein the extracting the first content feature from the first digital post comprises:
extracting both a first visual content feature and a first textual content feature from the first digital post; and
integrating the first visual content feature and the first textual content feature to generate a first integrated content feature;
wherein the extracting the second content feature from the second digital post comprises:
extracting both a second visual content feature and a second textual content feature from the second digital post; and
integrating the second visual content feature and the second textual content feature to generate a second integrated content feature; and
wherein aggregating the first content feature and the second content feature together comprises aggregating the first integrated content feature and the second integrated content feature.

12. The non-transitory computer readable medium of claim 8, further comprising training the neural network by:
extracting a content feature from each of a plurality of digital posts to an online social media platform associated with a plurality of users;
extracting metadata associated with each of the plurality of digital posts;
determining a venue category associated with each digital post based on the extracted metadata; and
optimizing one or more parameters of a predictor model based on an association between the determined venue category and the extracted content features; and
wherein the inferring at least one of a frequency and a regularity of visits to a venue category comprises inferring venue categories based on the aggregated first and second content features using the optimized predictor model.

13. The non-transitory computer readable medium of claim 12, wherein the extracted metadata comprises one or more of: Global Positioning System (GPS) data, geotag data, and check-in data associated with each digital post.

14. The non-transitory computer readable medium of claim 8, further comprising sorting the plurality of digital posts into a first group of digital posts and a second group of digital post based on temporal data associated with each digital post; and
wherein the inferring at least one of a frequency and a regularity of visits to a venue category comprises:
inferring a first at least one of a frequency and a regularity of visits to a venue category associated with the first group of digital posts; and
inferring a second at least one of a frequency and a regularity of visits to a venue category associated with the second group of digital post.

15. A server apparatus comprising:
a memory storing digital content posted to an online social media platform comprising a plurality of digital posts associated with a first user;
a processor executing a process comprising:
extracting a first content feature from a first digital post to an online social media platform selected from a plurality of digital posts;
extracting a second content feature from a second digital post to an online social media platform selected from the plurality of social media posts;
aggregating the first and second content features;
inferring at least one of a frequency and a regularity of visits to a venue category associated with the plurality of digital posts based on the aggregated first and second content features using a neural network; and
determining at least one of a frequently visited venue category and a regularly visited venue category based on the inferred frequency and a regularity of visits associated with the plurality of digital posts.

16. The server apparatus of claim 15, wherein the process further comprises automatically generating a digital communication, and sending the digital communication to a first user associated with the plurality of digital posts to the online social media platform based on the determined one of a frequently visited venue category and a regularly visited venue category.

17. The server apparatus of claim 15, wherein the extracting the first content feature from the first digital post comprises extracting at least one of a first visual content feature and a first textual content feature from the first digital post; and
wherein the extracting the second content feature from the second digital post comprises extracting at least one of a second visual content feature and a second textual content feature from the second digital post.

18. The server apparatus of claim 15, wherein the extracting the first content feature from the first digital post comprises:
extracting both a first visual content feature and a first textual content feature from the first digital post; and
integrating the first visual content feature and the first textual content feature to generate a first integrated content feature;
wherein the extracting the second content feature from the second digital post comprises:
extracting both a second visual content feature and a second textual content feature from the second digital post; and
integrating the second visual content feature and the second textual content feature to generate a second integrated content feature; and
wherein aggregating the first content feature and the second content feature together comprises aggregating the first integrated content feature and the second integrated content feature.

19. The server apparatus of claim 15, wherein the process further comprises training the convolutional neural network by:
extracting a content feature from each of a plurality of digital posts to an online social media platform associated with a plurality of users;
extracting metadata associated with each of the plurality of digital posts;
determining a venue category associated with each digital post based on the extracted metadata; and
optimizing one or more parameters of a predictor model based on an association between the determined venue category and the extracted content features; and
wherein the inferring at least one of a frequency and a regularity of visits to a venue category comprises inferring venue categories based on the aggregated first and second content features using the optimized predictor model.

20. The server apparatus of claim 15, wherein the process further comprises sorting the plurality of digital posts into a first group of digital posts and a second group of digital post based on temporal data associated with each digital post; and
wherein the inferring at least one of a frequency and a regularity of visits to a venue category comprises:
inferring a first at least one of a frequency and a regularity of visits to a venue category associated with the first group of digital posts; and
inferring a second at least one of a frequency and a regularity of visits to a venue category associated with the second group of digital post.
